(19) United States
(12) Patent Application Publication
(10) Pub. No.: US 2025/0319489 A1
(43) Pub. Date: Oct. 16, 2025

(54) VEHICLE EXTERIOR COMPONENT

(71) Applicant: TOYODA GOSEI CO., LTD., Kiyosu-shi (JP)

(72) Inventors: Kenta MATSUSHIMA, Kiyosu-shi (JP); Yukari ITO, Kiyosu-shi (JP); Hiroaki ANDO, Kiyosu-shi (JP)

(21) Appl. No.: 19/169,179

(22) Filed: Apr. 3, 2025

(30) Foreign Application Priority Data
Apr. 16, 2024 (JP) 2024-066263

(51) Int. Cl. B05D 7/14; B05D 7/00

(52) U.S. Cl. CPC B05D 7/14; B05D 7/58; B05D 2601/02

(57) ABSTRACT

A vehicle exterior component includes a cover configured to be disposed so as to be exposed toward an outside of a vehicle. The cover includes a base and a color-developing layer stacked on the base in a thickness direction. The color-developing layer includes an exterior color layer containing a large number of sparkle particles, and a concealing layer containing a white pigment and a black pigment. The area occupancy rate of the sparkle particles per unit area in the exterior color layer is in a range of 5% to 85%. The thicknesses of the exterior color layer and the concealing layer are set such that a transmittance of visible light falls within a range of 7% to 85%.

### CROSS-REFERENCE TO RELATED APPLICATIONS

This application is based upon and claims the benefit of priority from Japanese Patent Application No. 2024-066263, filed on Apr. 16, 2024, the entire contents of which are incorporated herein by reference.

### BACKGROUND

### 1. Field

The present disclosure relates to a vehicle exterior component.

### 2. Description of Related Art

The vehicle exterior component is configured to be attached to a vehicle. The vehicle exterior component includes a cover configured to be disposed so as to be exposed toward the exterior of the vehicle. Since the cover of the vehicle exterior component is exposed to the exterior of the vehicle, it is desirable to improve its aesthetic appearance.

To improve the aesthetic appearance of the cover of the vehicle exterior component, a primer coat and a metallic coating film may be formed, as disclosed in Japanese Patent No. 4079468, on the surface of the cover that faces the exterior of the vehicle. Specifically, a neutral gray primer coat in which a white pigment and a black pigment are blended is formed on the surface of the cover that faces the exterior of the vehicle. Additionally, a metallic coating film containing sparkle particles is formed over the gray primer coat. The metallic coating film contains a colored pigment or the like for coloration.

When the primer coat and the metallic coating film disclosed in the above publication are applied to the outer surface of the cover of the vehicle exterior component (the surface facing the exterior of the vehicle), the following advantages are achieved. Specifically, when light from the exterior of the vehicle is reflected by the metallic coating film and the primer coat, the color of the reflected light exhibits a sparkling effect and a sense of perceived depth. In other words, the appearance of the cover has a sparkling effect and a sense of perceived depth when viewed from the exterior of the vehicle.

However, if the area occupancy rate of the sparkle particles per unit area in the metallic coating is too low, the sparkling effect of the cover when viewed from the exterior of the vehicle diminishes. If the area occupancy rate of the sparkle particles per unit area in the metallic coating is too high, a large amount of shadow is generated by the sparkle particles when light is transmitted through the backside of the metallic coating, resulting in increased flickering due to the shadow. Additionally, if the area occupancy rate of the sparkle particles per unit area in the metallic coating is too high or if the thicknesses of the metallic coating and the primer coat are excessive, the visible light transmittance of the metallic coating and the primer coat decreases. Consequently, the color tone of the cover appears darker when viewed from the exterior of the vehicle.

Accordingly, if the area occupancy rate of the sparkle particles per unit area in the metallic coating and the thicknesses of the metallic coating and the primer coat are not appropriately set, the following issue may arise when the cover is viewed from the exterior of the vehicle. The sparkling effect of the cover may be reduced, flickering may become more pronounced, and the color tone of the cover may appear darker.

In one general aspect, a vehicle exterior component includes a cover configured to be disposed so as to be exposed toward an exterior of a vehicle. The cover includes a base and a color-developing layer that is stacked on the base in a thickness direction. The color-developing layer includes an exterior color layer containing a large number of sparkle particles, and a concealing layer containing a white pigment and a black pigment. An area occupancy rate of the sparkle particles per unit area in the exterior color layer is in a range of 5% to 85%. Thicknesses of the exterior color layer and the concealing layer are set such that a transmittance of visible light falls within a range of 7% to 85%.

Other features and aspects will be apparent from the following detailed description, the drawings, and the claims.

### BRIEF DESCRIPTION OF THE DRAWINGS

FIG. 1 is a schematic diagram showing the structure of a vehicle exterior component.

FIG. 2 is an enlarged cross-sectional view showing a portion surrounded by the long-dash double-short-dash line in the cover of the vehicle exterior component shown in FIG. 1.

FIG. 3 is a graph showing changes in the transmittance of visible light with respect to changes in the area occupancy rate of sparkle particles per unit area in an exterior color layer.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

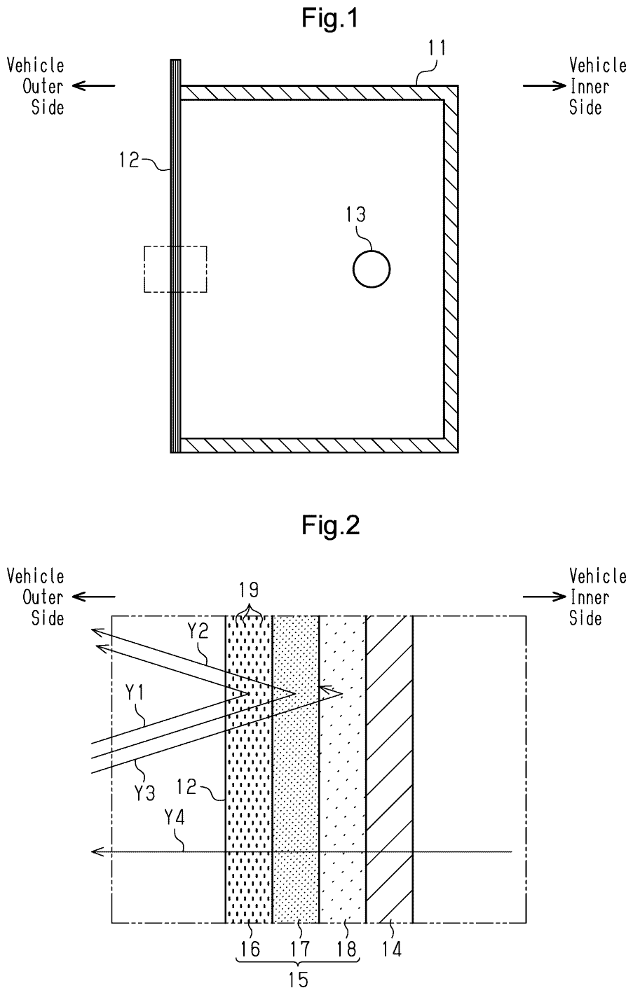

A vehicle exterior component according to an embodiment will now be described with reference to FIGS. 1 to 3.

The vehicle exterior component shown in FIG. 1 is configured to be attached to a vehicle. The vehicle exterior component includes a housing 11, a cover 12, and a light source 13. The housing 11 has an opening. The cover 12 covers the opening of the housing 11. The light source 13 is disposed in the housing 11. For example, an LED that emits white light may be used as the light source 13. When the vehicle exterior component is attached to a vehicle, the cover 12 of the vehicle exterior component is disposed so as to be exposed to the exterior of the vehicle, that is, to the left in FIG. 1.

### Cover 12

As shown in FIG. 2, the cover 12 includes a base 14 and a color-developing layer 15. The base 14 can transmit light from the light source 13, which is disposed in the housing 11. The color-developing layer 15 is stacked on the base 14 in the thickness direction. Specifically, the color-developing layer 15 is formed on a surface of the base 14 that faces the exterior of the vehicle, that is, the left side in FIG. 2.

The color-developing layer 15 includes an exterior color layer 16, a concealing layer 17, and a color adjustment layer 18. The exterior color layer 16 contains a large number of sparkle particles 19. The sparkle particles 19 are formed of, for example, aluminum. The sparkle particles 19 impart a sparkling effect to the color of light from the exterior of the vehicle when the light is reflected by the exterior color layer 16 as indicated by arrow Y1. In other words, the sparkle particles 19 impart a sparkling effect to the appearance of the cover 12 from the exterior of the vehicle. The exterior color layer 16 may contain a colored pigment in order to adjust the color of reflected light when light from the exterior of the vehicle is reflected by the exterior color layer 16.

The concealing layer 17 is formed on a surface of the exterior color layer 16 that faces the base 14. The concealing layer 17 contains a white pigment and a black pigment. The concealing layer 17 enhances the perceived depth of the appearance of the cover 12 by influencing the reflected light. Specifically, when light from the exterior of the vehicle is reflected by both the exterior color layer 16, as indicated by arrow Y1, and the concealing layer 17, as indicated by arrow Y2, the combined reflections contribute to the depth effect of the appearance of the cover 12.

The color adjustment layer 18 is located closer to the light source 13 than the exterior color layer 16 and the concealing layer 17 are. In other words, the color adjustment layer 18 is located between the concealing layer 17 and the base 14. The color adjustment layer 18 adjusts the color of the light from the light source 13 transmitted through the exterior color layer 16, the concealing layer 17, and the color adjustment layer 18, as indicated by arrow Y4. Specifically, the color adjustment layer 18 causes the light from the light source 13, which is transmitted through the exterior color layer 16, the concealing layer 17, and the color adjustment layer 18, to appear white.

### Details of Each Layer in Cover 12

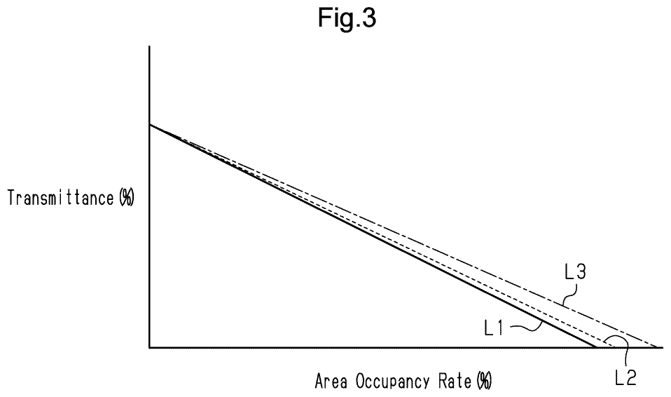

FIG. 3 shows changes in the transmittance of visible light in the exterior color layer 16 with respect to changes in the area occupancy rate of the sparkle particles 19 per unit area in the exterior color layer 16. Solid line L1 in FIG. 3 represents changes in the transmittance with respect to changes in the area occupancy rate in a case in which the average particle size of the sparkle particles 19 is 6.4 mm. Broken line L2 in FIG. 3 represents changes in the transmittance with respect to changes in the area occupancy rate in a case in which the average particle size of the sparkle particles 19 is 12.0 mm. Long-dash short-dash line L3 in FIG. 3 represents changes in the transmittance with respect to changes in the area occupancy rate in a case in which the average particle size of the sparkle particles 19 is 22.2 mm.

The area occupancy rate of the sparkle particles 19 per unit area in the exterior color layer 16 according to the present embodiment is in a range of 5% to 85%. As a result, when light from the exterior of the vehicle is reflected by the exterior color layer 16, the color of the reflected light exhibits a sparkling effect. In other words, the appearance of the cover 12 has a sparkling effect when viewed from the exterior of the vehicle. Further, it is also possible to suppress an increase in flickering due to the influence of the shadow of the sparkle particles 19 when light strikes the exterior color layer 16. The area occupancy of the sparkle particles 19 per unit area in the exterior color layer 16 is more preferably in a range of 30% to 60%.

The thicknesses of the exterior color layer 16 and the concealing layer 17 are set such that the transmittance of visible light falls within a range of 7% to 85%. This configuration helps prevent the color tone of the cover 12 from appearing too dark when viewed from outside the vehicle. The thicknesses of the exterior color layer 16 and the concealing layer 17 are preferably set such that the transmittance of visible light falls within a range of 20% to 60% when the area occupancy of the sparkle particles 19 per unit area in the exterior color layer 16 is in the range of 30% to 60%.

When white light is transmitted through the exterior color layer 16, the light transmitted through the exterior color layer 16 may be colored depending on the color of the pigments contained in the exterior color layer 16. The color adjustment layer 18 contains pigments of a color, for example, green, for maintaining the white color when the white color light is transmitted through the color adjustment layer 18 and the exterior color layer 16 as indicated by arrow Y4. The light from the exterior of the vehicle is also reflected by the color adjustment layer 18 as indicated by arrow Y3. However, even if the light from the exterior of the vehicle is reflected by the color adjustment layer 18, the reflected light is blocked by the concealing layer 17. As a result, the coloration of the color adjustment layer 18 is prevented from being visible from the exterior of the vehicle.

The vehicle exterior component according to the present embodiment has the following advantages.
(1) Light from the exterior of the vehicle is reflected by the exterior color layer 16, so that the coloration of the cover 12 is determined by the exterior color layer 16. The area occupancy rate of the sparkle particles 19 per unit area in the exterior color layer 16 is in the range of 5% to 85%. Thus, when light from the exterior of the vehicle is reflected by the exterior color layer 16, the color of the reflected light exhibits a sparkling effect. In other words, the appearance of the cover 12 has a sparkling effect when viewed from the exterior of the vehicle. Further, since the area occupancy of the sparkle particles 19 per unit area in the exterior color layer 16 is set to 5% to 85%, it is possible to suppress an increase in flickering due to the influence of the shadow of the sparkle particles 19 when light strikes the exterior color layer 16. Additionally, the concealing layer 17, which contains the white pigment and the black pigment, prevents a portion of the vehicle exterior component on the inner side of the cover 12 from being seen from the outside of the vehicle. The thicknesses of the exterior color layer 16 and the concealing layer 17 are set such that the visible light transmittance falls within the range of 7% to 85%. This configuration helps prevent the color tone of the cover 12 from appearing too dark when viewed from outside the vehicle.
(2) When the light source 13 is turned on, light emitted from the light source 13 is transmitted through the concealing layer 17 and the exterior color layer 16. Since the area occupancy of the sparkle particles 19 per unit area in the exterior color layer 16 is in the range of 5% to 85%, it is possible to suppress an increase in flickering due to the influence of the shadow of the sparkle particles 19 of the exterior color layer 16 even in this case.
(3) When the light from the light source 13 is transmitted through the exterior color layer 16, the concealing layer 17, and the color adjustment layer 18, the transmitted light can be adjusted to a desired color by the color adjustment layer 18.
(4) When the light from the light source 13 is transmitted through the exterior color layer 16, the concealing layer 17, and the color adjustment layer 18, the color adjustment layer 18 adjusts the transmitted light so that the light appears white. As a result, when the light source 13 is turned on, the cover 12 appears white when viewed from the exterior of the vehicle.

The above-described embodiment may be modified as follows. The above-described embodiment and the following modifications can be combined as long as the combined modifications remain technically consistent with each other.

The position of the exterior color layer 16 and the position of the concealing layer 17 may be interchanged.

The color-developing layer 15 may be stacked on the surface of the base 14 that faces the light source 13, that is, the surface on the right side in FIG. 2.

The light source 13 may emit a color other than white light. In this case, the color adjustment layer 18 adjusts the transmitted light so that the light appears white when the light is transmitted through the exterior color layer 16, the concealing layer 17, and the color adjustment layer 18.

When the light from the light source 13 is transmitted through the exterior color layer 16, the concealing layer 17, and the color adjustment layer 18, the color adjustment layer 18 adjusts the transmitted light to appear a color other than white.

The sparkle particles 19 may be formed from a sparkle material other than aluminum.

The light source 13 does not necessarily need to be provided. In this case, the color adjustment layer 18 may be omitted.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising a cover configured to be disposed so as to be exposed toward an exterior of a vehicle, wherein
the cover includes:
a base; and
a color-developing layer that is stacked on the base in a thickness direction, the color-developing layer includes:
an exterior color layer containing a large number of sparkle particles; and
a concealing layer containing a white pigment and a black pigment,
an area occupancy rate of the sparkle particles per unit area in the exterior color layer is in a range of 5% to 85%, and
thicknesses of the exterior color layer and the concealing layer are set such that a transmittance of visible light falls within a range of 7% to 85%.

2. The vehicle exterior component according to claim 1, further comprising a housing having an opening and a light source disposed within the housing, wherein
the cover covers the opening of the housing, and
the base is capable of transmitting light from the light source.

3. The vehicle exterior component according to claim 2, wherein
the color-developing layer includes a color adjustment layer located closer to the light source than the exterior color layer and the concealing layer are, and
the color adjustment layer adjusts a color of the light from the light source transmitted through the exterior color layer, the concealing layer, and the color adjustment layer.

4. The vehicle exterior component according to claim 3, wherein the color adjustment layer causes the light from the light source, which is transmitted through the exterior color layer, the concealing layer, and the color adjustment layer, to appear white.
